(19) United States
(12) Patent Application Publication
(10) Pub. No.: US 2025/0191600 A1
(43) Pub. Date: Jun. 12, 2025

(54) MULTI-FEATURE AI NOISE REDUCTION

(71) Applicants: Advanced Micro Devices, Inc., Santa Clara, CA (US); ATI Technologies ULC, Markham (CA)

(72) Inventors: Carl Wakeland, Santa Clara, CA (US); Geoffrey Park, Markham (CA)

(73) Assignees: Advanced Micro Devices, Inc., Santa Clara, CA (US); ATI Technologies ULC, Markham (CA)

(21) Appl. No.: 18/088,125

(22) Filed: Dec. 23, 2022

(51) Int. Cl. G10L 21/0232; G10L 25/27

(52) U.S. Cl. CPC G10L 21/0232; G10L 25/27

(57) ABSTRACT

The disclosed computer-implemented method includes transforming, from a time domain into a frequency domain, a sound signal into a transformed sound signal. The transformed sound signal has a phase component and a magnitude component. The method also includes filtering the phase component of the transformed sound signal by applying a quantized mask from a machine-learning model to the phase component, and generating a filtered sound signal by transforming, from the frequency domain into the time domain, the transformed sound signal comprising the magnitude component and the filtered phase component. Various other methods, systems, and computer-readable media are also disclosed.

### BACKGROUND

Noise suppression or noise reduction involves removing noise from a signal. When recording a sound, such as a person's voice, background sounds may also be recorded as noise to the detriment of a quality of the voice recording. Noise may further affect a quality of processing the voice recording, such as for speech recognition, broadcasting for communication, etc. Thus, various noise reduction techniques may remove or otherwise reduce noise sounds from a recorded sound signal.

Artificial intelligence (AI) based noise reduction techniques may use a machine-learning (ML) model to filter noise. AI-based noise reduction techniques often use a machine-learning model trained to recognize noise in a single feature (e.g., a magnitude component) of a frequency-domain sound signal. For instance, after transforming a source sound signal into the frequency domain from the time domain, a magnitude of the transformed signal may be extracted and fed into the ML model. The ML model may generate a mask that, when applied to the magnitude, filters noise from the magnitude. The filtered magnitude may be recombined with an original phase component of the transformed signal and converted back into the time domain.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for multi-feature AI noise reduction.

FIG. 2 is a diagram of an example machine-learning model training.

FIG. 3 is a flow diagram of an example process for AI noise reduction.

FIG. 4 is a flow diagram of an example process for multi-feature AI noise reduction.

FIG. 5 is a flow diagram of an exemplary method for multi-feature AI noise reduction.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

As will be described in greater detail below, the present disclosure describes various systems and methods for multi-feature AI noise reduction. After converting a sound signal into the frequency domain, the phase component of the transformed signal is filtered separately from the magnitude component of the transformed signal by applying an ML model that may be smaller than an ML model for the magnitude component. In some examples, the phase component is filtered using a quantized mask generated by the ML model. The filtered phase and magnitude components are recombined and converted back into the time domain to generate a filtered sound signal.

In one example, a method for multi-feature AI noise reduction includes transforming, by a transform module from a time domain into a frequency domain, a sound signal into a transformed sound signal. The transformed sound signal includes a magnitude component and a phase component. The method also includes filtering, by an artificial intelligence (AI) module, the phase component of the transformed sound signal by applying a quantized mask from machine-learning model to the phase component, and generating, by the transform module, a filtered sound signal by transforming, from the frequency domain into the time domain, the transformed sound signal that includes the magnitude component (which can also be filtered) and the filtered phase component.

In some examples, applying the quantized mask includes dequantizing the quantized mask, and applying the dequantized mask to the phase component to filter the phase component. In some examples, the AI module generates the quantized mask using the machine-learning model.

In some examples, the method further includes filtering the magnitude component of the transformed sound signal by applying a second machine-learning model. In such examples, generating the filtered sound signal also includes transforming, from the frequency domain into the time domain, the transformed sound signal that includes the filtered magnitude component and the filtered phase component. In some examples, the method further includes filtering, by the AI module, the phase component in parallel with filtering the magnitude component. In some examples, the machine-learning model for the phase component is smaller than the second machine-learning model for the magnitude component.

In some examples, transforming the sound signal into the transformed sound signal also includes splitting the sound signal into overlapping segments, applying a window function to each overlapping segment, and transforming the overlapping segments from the time domain into the frequency domain. In some examples, filtering the phase component further includes filtering the phase component of each of the overlapping segments by applying the machine-learning model. In some examples, generating the filtered sound signal also includes transforming the overlapping segments from the frequency domain into the time domain and reconstructing the segments into the filtered sound signal.

In some examples, the machine-learning model is trained to filter noise. In some examples, transforming the sound signal from the time domain into the frequency domain uses a Fourier transform and transforming the filtered sound signal from the frequency domain into the time domain uses an inverse Fourier transform.

In one example, a system for multi-feature AI noise reduction includes a physical memory, at least one physical processor, a transform circuit, and an AI circuit. The transform circuit is configured to transform, from a time domain into a frequency domain, a sound signal into a transformed sound signal. The transformed sound signal includes a first feature component and a second feature component. The AI module is configured to filter the first feature component of the transformed sound signal by applying a quantized mask from a first machine-learning model to the first feature component and filter the second feature component of the transformed sound signal by applying a second machine-learning model to the second feature component. The transform circuit is further configured to generate a filtered sound signal by transforming, from the frequency domain into the time domain, the transformed sound signal that includes the filtered first feature component and the filtered second feature component.

In some examples, the AI circuit is configured to apply the quantized mask to the first feature component by dequantizing the quantized mask and applying the dequantized mask to the first feature component. In some examples, the quantized mask is not applied to the second feature component to leave the second feature component unfiltered. In some examples, the method includes filtering the first feature component in parallel with filtering the second feature component. In some examples, the first machine-learning model is smaller than the second machine-learning model. In some examples, the first feature component corresponds to a phase component and the second feature component corresponds to a magnitude component. In some examples, the first machine-learning model is trained to filter noise from the first feature component and the second machine-learning model is trained to filter noise from the second feature component.

In some examples, the transform circuit is further configured to transform the sound signal into the transformed sound signal by splitting the sound signal into overlapping segments, and transforming the overlapping segments from the time domain into the frequency domain. In some examples, the AI circuit is further configured to filter the first feature component by filtering the first feature component of each of the overlapping segments by applying the quantized mask from the first machine-learning model. In some examples, the AI circuit is further configured to filter the second feature component by filtering the second feature component of each of the overlapping segments by applying the second machine-learning model. In some examples, the transform circuit is further configured to generate the filtered sound signal by transforming the overlapping segments from the frequency domain into the time domain and reconstructing the segments into the filtered sound signal.

In some examples, the first machine-learning model is trained to filter noise from the first feature component and the second machine-learning model is trained to filter noise from the second feature component.

In some examples, the above-described method is encoded as computer-readable instructions on a non-transitory computer-readable medium. For example, a computer-readable medium includes one or more computer-executable instructions that, when executed by at least one processor of a computing device, causes the computing device to transform, from a time domain into a frequency domain, a sound signal into a transformed sound signal that includes a phase component and a magnitude component. The instructions cause the computing device to filter the phase component of the transformed sound signal by applying a quantized mask from a first machine-learning model to the first feature component and filter the magnitude component of the transformed sound signal by applying a second machine-learning model to the second feature component. The instructions also cause the computing device to generate a filtered sound signal by transforming, from the frequency domain into the time domain, the transformed sound signal that includes the filtered first feature component and the filtered second feature component.

In some examples, the instructions for applying the quantized mask further includes instructions for dequantizing the quantized mask and applying the dequantized mask to filter the phase component. In some examples, the instructions cause the computing device to filter the first feature component in parallel with filtering the second feature component. In some examples, the first machine-learning model is smaller than the second machine-learning model.

Features from any of the above-mentioned implementations can be used in combination with one another in accordance with the general principles described herein. These and other implementations, features, and advantages will be more fully understood upon reading the following detailed description in conjunction with the accompanying drawings and claims.

The present disclosure is generally directed to multi-feature AI noise reduction. As will be explained in greater detail below, implementations of the present disclosure provide for filtering a phase component, in addition to a magnitude component, of a frequency-domain converted sound signal by using separate ML models for the phase component and the magnitude component. The ML model for the phase component can also provide a quantized mask for filtering the phase component. By using a separate ML model for filtering the phase component in parallel with the magnitude component, the systems and methods provided herein may improve the functioning of a computer itself by providing for efficient filtering the phase component without requiring significant additional computing resources. The systems and methods provided herein may also improve the technical field of noise reduction by providing for filtering of multiple features (e.g., the phase component and the magnitude component of a frequency-domain signal).

Features from any of the implementations described herein can be used in combination with one another in accordance with the general principles described herein. These and other implementations, features, and advantages will be more fully understood upon reading the following detailed description in conjunction with the accompanying drawings and claims.

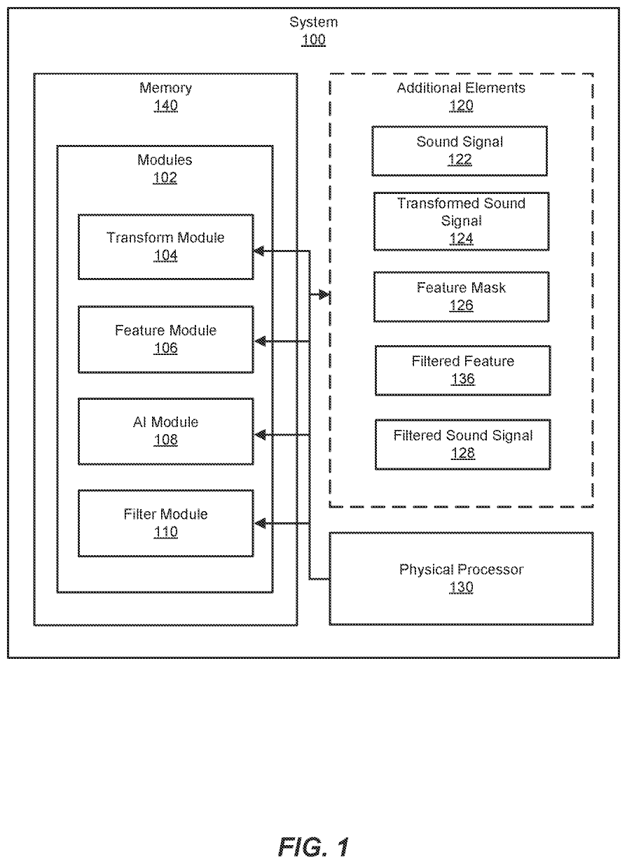

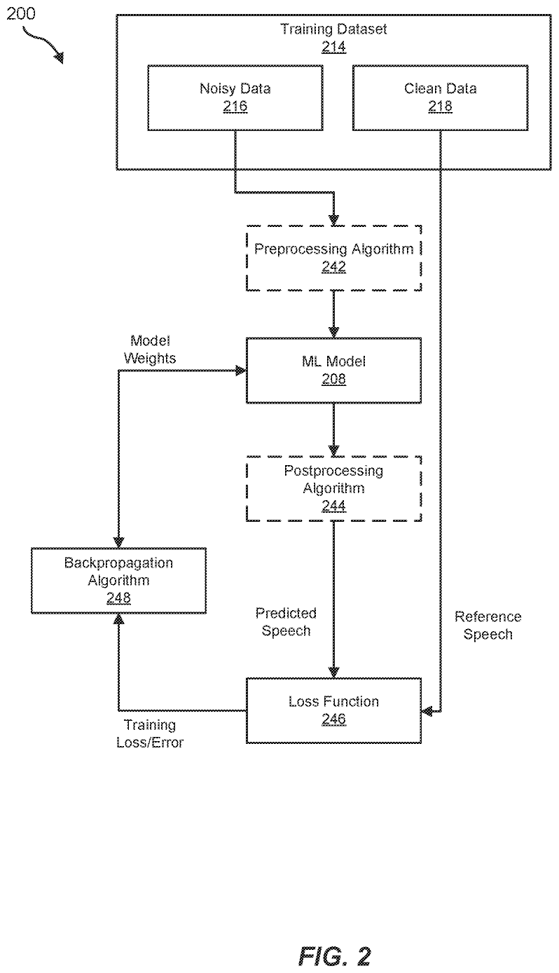

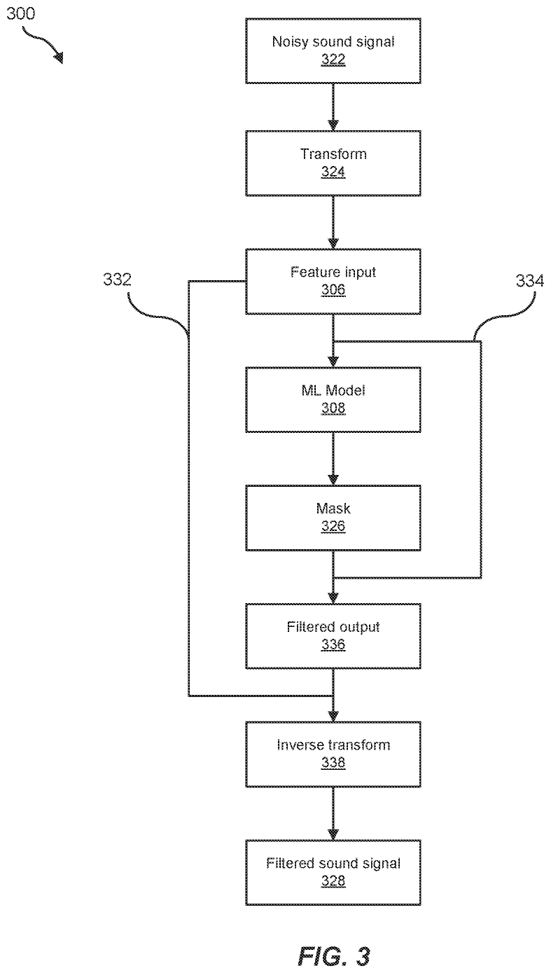

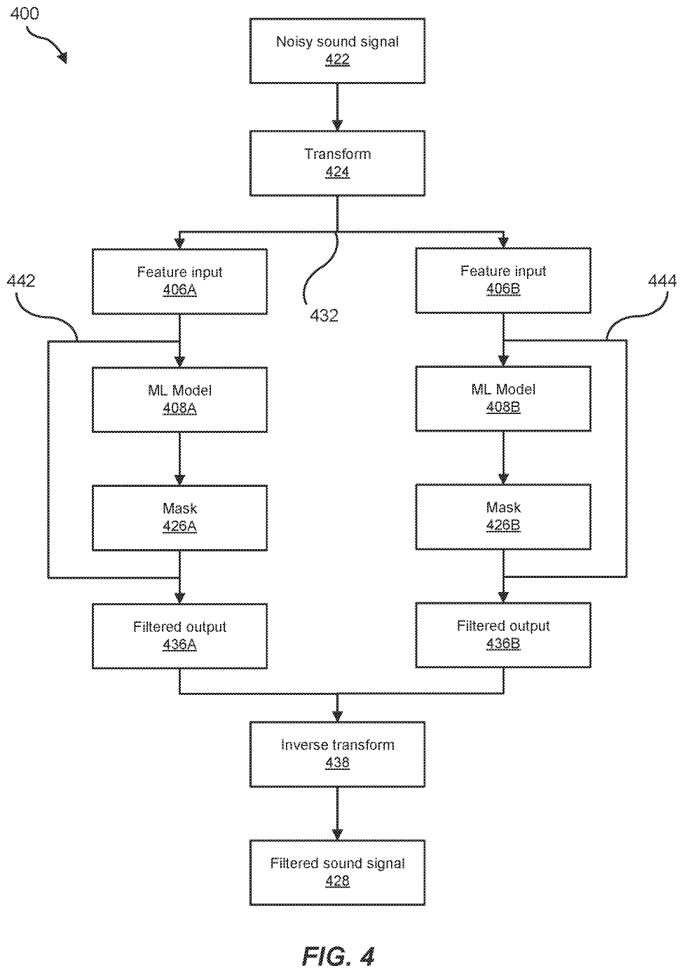

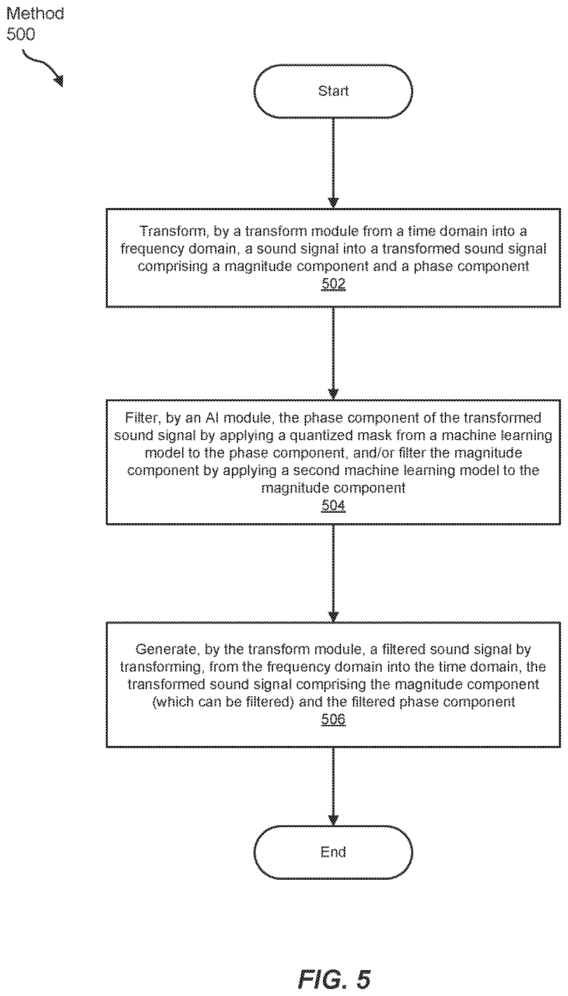

The following will provide, with reference to FIGS. 1-5, detailed descriptions of multi-feature AI noise reduction. Detailed descriptions of an example system will be provided in connection with FIG. 1. Detailed descriptions of training an ML model for noise reduction will be provided in connection with FIG. 2. Detailed descriptions of an example process for AI noise reduction will be provided in connection with FIG. 3. Detailed descriptions of an example process for multi-feature AI noise reduction will be provided in connection with FIG. 4. Detailed descriptions of corresponding computer-implemented methods will also be provided in connection with FIG. 5.

FIG. 1 is a block diagram of an example system 100 for multi-feature AI noise reduction. As illustrated in this figure, example system 100 includes one or more modules 102 for performing one or more tasks. As will be explained in greater detail herein, modules 102 include a transform module 104, a feature module 106, an AI module 108, and a filter module 110. Although illustrated as separate elements, one or more of modules 102 in FIG. 1 can represent portions of a single module, circuit, or application.

In certain implementations, one or more of modules 102 in FIG. 1 can represent one or more software applications or programs that, when executed by a computing device, cause the computing device to perform one or more tasks. For example, and as will be described in greater detail below, one or more of modules 102 represent modules stored and configured to run on one or more computing devices. In certain implementations, a module is implemented in hardware, such that one or more of modules 102 is implemented as one or more circuits. One or more of modules 102 in FIG. 1 can also represent all or portions of one or more special-purpose computers configured to perform one or more tasks. In some implementations, transform module 104 is implemented as a transform circuit, feature module 106 is implemented as a feature circuit, AI module 108 is implemented as an AI circuit, and filter module 110 is implemented as a filter circuit.

As illustrated in FIG. 1, example system 100 also includes one or more memory devices, such as memory 140. Memory 140 generally represents any type or form of volatile or non-volatile storage device or medium capable of storing data and/or computer-readable instructions. In one example, memory 140 stores, loads, and/or maintains one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 also includes one or more physical processors, such as physical processor 130. Physical processor 130 generally represents any type or form of hardware-implemented processing unit capable of interpreting and/or executing computer-readable instructions. In one example, physical processor 130 accesses and/or modifies one or more of modules 102 stored in memory 140. Additionally or alternatively, physical processor 130 executes one or more of modules 102 to facilitate maintain the mapping system. Examples of physical processor 130 include, without limitation, microprocessors, microcontrollers, Central Processing Units (CPUs), graphical processing units (GPUs), Field-Programmable Gate Arrays (FPGAs) that implement softcore processors, Application-Specific Integrated Circuits (ASICs), systems on a chip (SOCs), digital signal processors (DSPs), Neural Network Engines (NNEs), accelerators, graphics processing units (GPUs), portions of one or more of the same, variations or combinations of one or more of the same, and/or any other suitable physical processor.

As illustrated in FIG. 1, example system 100 also includes one or more additional elements 120, such as a sound signal 122, a transformed sound signal 124, a feature mask 126, a filtered feature 136, and a filtered sound signal 128. Sound signal 122, transformed sound signal 124, feature mask 126, filtered features 136, and/or filtered sound signal 128 can be stored on a local storage device, such as memory 140, or can be accessed remotely. Sound signal 122 represents a source sound signal, as will be explained further below. Transformed sound signal 124 represents sound signal 122 transformed from a time domain into a frequency domain. Feature mask 126 represents an AI-generated mask for filtering sounds from a feature (e.g., a phase and/or a magnitude) of transformed sound signal 124. Filtered feature 136 corresponds to an extracted feature of transformed sound signal 124 having feature mask 126 applied. Filtered sound signal 128 represents a reconstruction of sound signal 122 after filtering features, as will be explained further below.

FIG. 2 illustrates an example training process 200 for training a machine-learning model. A training dataset 214 includes noisy data 216 and clean data 218 for training a machine-learning (ML) model 208 (which corresponds to AI module 108) in conjunction with a loss function 246 and a backpropagation algorithm 248. A preprocessing algorithm 242 and a postprocessing algorithm 244, which are optional in some examples, are also illustrated. As described herein, ML model 208 corresponds to one or more ML schemes, such as a deep neural network (DNN), a convolutional neural network (CNN), a recurrent neural network (RNN), a deep recurrent neural network (DRNN), a spiking neural network (SNN), a long short-term memory (LSTM) network, etc.

Neural networks can be modeled after interconnected neurons, arranged in connected layers similar to groups of connected neurons. Each layer can receive an input tensor, process the input tensor, and pass an output tensor to the next layer until the final layer produces a final output tensor. Each layer can also assign weights to its input tensor as well as apply filters to inputs for outputting to the next layer. For example, if a task involves identifying a particular sound (e.g., noise) from a source signal represented as a series of tensors, these weights can correspond to a probability that a sound represented by an input tensor matches the particular sound. The filters and weights for the layers can be determined through training. Training can involve using a training dataset that includes input tensors paired with reference output tensors. By feeding an input tensor into the ML model and comparing the predicted output tensor of the ML model with the corresponding reference tensor using a loss function, and then backpropagating the differences computed by the loss function through the model layers in an iterative process, the ML model can update its weights to reduce an error between the predicted output tensor and the reference tensor. This process can be repeated over the entire training dataset. One set of iterations of the process performed over the entire training dataset is referred to as an epoch. Upon the completion of an epoch, the training sample order can then be shuffled, and training can continue through successive epochs until the computed error from the loss function cannot be reduced any further.

Clean data 218, which corresponds to the reference data described above, includes clean sound samples, such as clean voice samples without background noise. Noisy data 216 includes sound data of noises mixed with the same clean voice samples of clean data 218, which can be selected for training. Noisy data 216 includes samples of various types of noise to be filtered. For example, noisy data 216 can include types of noise that can be expected when recording one's voice, such as animal/pet sounds, car/machinery sounds, wind sounds, and other large sudden sounds. Training dataset 214, and more specifically noisy data 216, are input into ML model 208. Clean data 218 (e.g., the reference speech) can be fed to loss function 246 that can also be connected to an output of ML model 208 (e.g., the predicted speech). The output of loss function 246 (e.g., the training loss or error) can be fed to backpropagation algorithm 248 to update the weights of ML model 208 as described herein.

In some examples, ML model 208 is trained for a specific component of a signal. A particular feature can be extracted from training dataset 214 using preprocessing algorithm 242 and fed into ML model 208. For example, training dataset 214 is transformed from a time domain into a frequency domain, and a magnitude or a phase of the transformed data is extracted and fed into ML model 208. In some examples, ML model 208 is trained for a particular feature, such as magnitude, such that another ML model 208 is separately trained for a different feature, such as phase.

FIG. 3 illustrates an example process 300 for AI noise reduction. Noisy sound signal 322 (which may correspond to sound signal 122), is transformed by transform 324 from a time domain to a frequency domain. Transform 324 can correspond to a Fourier transform, such as discrete Fourier transform, short time Fourier transform, etc. A transformed signal output from transform 324 is input into feature input 306 to extract a feature 334 and a second feature 332. Feature 334 corresponds to a component of the transformed signal, which can include, for instance, a magnitude component and a phase component. In some examples, feature 334 corresponds to the extracted magnitude component of the transformed signal and second feature 332 corresponds to the extracted phase component of the transformed signal.

In some implementations, the frequency domain corresponds to representing a signal with respect to frequency rather than time (e.g., time domain). The time domain shows how a sound signal's amplitude (e.g., loudness) can change over time. The frequency domain shows how much of the sound signal lies within each given frequency band over a range of frequencies. A magnitude component of the frequency-domain signal corresponds to a strength of a frequency component relative to other frequencies. A phase component corresponds to how the frequency components may align in time.

Feature 334 are input into a ML model 308, which corresponds to ML model 208. ML model 308 has previously been trained for the particular feature. For example, ML model 308 is trained to generate a mask (e.g., a mask 326) for the magnitude component. Mask 326 (which corresponds to feature mask 126) includes values that when applied to feature 334, would remove what ML model 308 was trained to recognize as noise.

After ML model 308 generates mask 326, mask 326 is applied to feature 334 to filter noise. Applying a mask includes, in some examples, multiplying values of the feature with values of the mask. For instance, feature 334 is multiplied by mask 326 to create filtered output 336. Filtered output 336 is recombined with second feature 332 (e.g. the phase component that has not been filtered) and transformed at inverse transform 338. Inverse transform 338 corresponds to an inverse of transform 324. Applying inverse transform 338 generates a filtered sound signal 328, which corresponds to filtered sound signal 128.

FIG. 4 illustrates an example process 400 for multi-feature AI noise reduction. Noisy sound signal 422 (which corresponds to sound signal 122), is transformed by transform 424 from a time domain to a frequency domain. Transform 424 corresponds to a Fourier transform, such as discrete Fourier transform, short time Fourier transform, etc. A transformed signal 432 is input into feature input 406A to extract a first feature 442. First feature 442 corresponds to a component of transformed signal 432. Transformed signal 432 includes, for instance, a magnitude component and a phase component. In some examples, first feature 442 corresponds to the extracted phase component of transformed signal 432.

First feature 442 is input into a ML model 408A (which corresponds to ML model 208). ML model 408A has previously been trained for the particular feature. For example, ML model 408A is trained to generate a mask (e.g., a mask 426A) for the phase component. Mask 426A (which corresponds to feature mask 126) includes values that when applied to first feature 442, would remove what ML model 408A was trained to recognize as noise.

In some examples, ML model 408A is quantized such that mask 426A is a quantized mask. Quantization of ML model 408A involves reducing a range of values for inputs and/or outputs. Reducing the range of values (e.g., reducing to a range between an expected minimum value and an expected maximum value) reduces a data unit size for computation (e.g., to int8 or int16 or other appropriate formats), which in turn reduces a computational complexity and computational resources needed by ML model 408A. Although quantization can introduce quantization errors, by limiting application of quantization to the ML model (e.g., ML model 408A operating in the reduced range, such as int8 or int16) that predicts a filtering mask for a particular extracted feature (e.g., the phase component of the frequency-domain transformed signal) the quantization errors can be reduced or otherwise mitigated without significantly reducing a signal quality of the original source signal.

After ML model 408A generates mask 426A, mask 426A is applied to first feature 442 to filter noise. For instance, first feature 442 is multiplied by mask 426A to create filtered output 436A. In some examples, if mask 426A is a quantized mask, mask 426A is dequantized before applying to first feature 442. Dequantizing mask 426A includes changing a format of mask 426A to match a data format of the speech signal (e.g., noisy sound signal 422 and/or first feature 442). For example, if the speech signal was in a float format and quantized mask 426A was int8, quantized mask 426A is converted from int8 to float before multiplying mask 426A with first feature 442.

Transformed signal 432 is also be input into feature input 406B to extract a second feature 444. Second feature 444 corresponds to another component of transformed signal 432. In some examples, second feature 444 corresponds to the extracted magnitude component of transformed signal 432.

Second feature 444 is input into a ML model 408B, which corresponds to ML model 208. ML model 408B has previously been trained for the particular feature. For example, ML model 408B is trained to generate a mask (e.g., a mask 426B) for the magnitude component. Mask 426B, which corresponds to feature mask 126, includes values that when applied to second feature 444, would remove what ML model 408B was trained to recognize as noise.

After ML model 408B generates mask 426B, mask 426B is applied to second feature 444 to filter noise. For instance, second feature 444 is multiplied by mask 426B to create filtered output 436B. Similar to ML model 408A and mask 426A as described herein, ML model 408B is quantized such that ML model 408B produces a quantized mask 426B. Before applying mask 426B to second feature 444, mask 426B is converted from a quantized format to a format of second feature 444.

As illustrated in FIG. 4, filtered output 436A is generated separately from filtered output 436B. In some examples, filtered output 436A is generated in parallel with filtered output 436B. In some examples, filtered output 436B follows a similar processing path as that of filtered output 336 in FIG. 3.

Filtered output 436A is recombined with filtered output 436B and transformed at inverse transform 438. Inverse transform 438 corresponds to an inverse of transform 424, such as an inverse Fourier transform. In some examples, as part of inverse transform 438, filtered output 436A (e.g., the filtered phase component) and filtered output 436B (e.g., the filtered magnitude component) are combined into a complex number component before the inverse Fourier transform is applied. Applying inverse transform 438 generates a filtered sound signal 428 (which corresponds to filtered sound signal 128).

FIG. 5 is a flow diagram of an exemplary computer-implemented method 500 for multi-feature AI noise reduction. The steps shown in FIG. 5 are performed by any suitable computer-executable code and/or computing system, including the system(s) illustrated in FIGS. 1 and/or Error! Reference source not found. In one example, each of the steps shown in FIG. 5 can represent an algorithm whose structure includes and/or is represented by multiple sub-steps, examples of which will be provided in greater detail below.

As illustrated in FIG. 5, at step 502 one or more of the systems described herein transforms, from a time domain into a frequency domain, a sound signal into a transformed sound signal comprising a magnitude component and a phase component. For example, transform module 104 transforms sound signal 122, from the time domain to the frequency domain, into transformed sound signal 124. Transformed sound signal 124 includes various features, including a phase component and a magnitude component.

The systems described herein can perform step 502 in a variety of ways. In one example, transforming the sound signal from the time domain into the frequency domain includes using a Fourier transform, which in some examples is followed by mathematical functions to extract the magnitude and phase components of the Fourier-transformed sound signal. For instance, transform module 104 uses any appropriate Fourier transform for transforming sound signal 122 into transformed sound signal 124.

In some examples, sound signal 122 is further processed, before and/or during the transform process, for improved filtering. For example, transform module 104 splits sound signal 122 into multiple overlapping segments. The segments overlap in time such that an end of a segment overlaps a beginning of the next segment. A window function, such as a Hann window, a Hamming window, and/or any of a variety of other window functions, is applied to the segments. In some examples, applying the window function includes multiplying the window function by each overlapping segment. Transform module 104 transforms the overlapping segments from the time domain into the frequency domain such that transformed sound signal 124 includes the transformed segments. In such examples, the steps of method 500 are generally be performed on each segment. In some examples, transformed sound signal 124 is called a spectrogram.

At step 504 one or more of the systems described herein filters the phase component of the transformed sound signal by applying a quantized mask from a machine-learning model to the phase component. For example, AI module 108 generates feature mask 126 for creating filtered feature 136. In some examples, features mask 126 is a quantized mask based on a reduced range of values and/or reduced data format size used by AI module 108. In some examples, one or more of the systems described herein filters the magnitude component of the transformed sound signal by applying a second machine-learning model to the magnitude component. For instance, AI module 108 generates a second feature mask 126 for creating a second filtered feature 136.

The systems described herein can perform step 504 in a variety of ways. In one example, AI module 108 is trained to filter noise, and in some examples, trained to filter noise for a particular feature such as a phase component or a magnitude component of a frequency-domain transformed sound signal. Feature module 106 extracts the feature (e.g., phase component) of transformed sound signal 124.

In some examples, AI module 108 generates, using an ML model as described herein, a mask (e.g., feature mask 126) for the phase component. As described herein, AI module 108 includes an ML model trained to identify noise in a phase component and generate the mask for filtering the noise. In some examples, the ML model is a quantized ML model to reduce a size and/or complexity of the ML model, as described herein. AI module 108 uses the quantized ML model (trained to identify noise in the phase component) to generate the quantized mask for filtering the noise. AI module 108 applies feature mask 126 to the phase component, for instance by multiplying feature mask 126 with the phase component to generate filtered feature 136. In some examples, AI module 108 applies feature mask 126 by dequantizing feature mask 126, and applying dequantized feature mask 126 to the phase component (e.g., by multiplying dequantized feature mask 126 with the phase component) to filter the phase component. Filtered feature 136 may correspond to the extracted phase component with feature mask 126 applied.

In some examples, other features of transformed sound signal 124 (e.g., the magnitude component) are also filtered. The magnitude component is filtered by applying a second ML model. The second ML model is applied to the magnitude component for filtering, similar to how the phase component is filtered. For example, after extracting the magnitude component from transformed sound signal 124, AI module 108 generates feature mask 126 for the magnitude component and multiplies feature mask 126 by the magnitude component to generate filtered feature 136 for the magnitude component. In some examples, the second ML model and corresponding feature mask 126 for the magnitude component are not quantized. In yet other examples, the second ML model and corresponding feature mask 126 for the magnitude component are quantized such that AI module 108 generates quantized feature mask 126 for the magnitude component. In such examples, AI module 108 generates filtered feature 136 for the magnitude component by dequantizing feature mask 126 and multiplying dequantized feature mask 126 by the magnitude component.

In some examples, AI module 108 filters the phase component in parallel with the magnitude component. In addition, the ML model for the phase component is, in some examples, smaller than the ML model for the magnitude component, as described herein. An ML model size refers to, for instance, dimensions (e.g., size and/or number of layers and/or nodes) of the model, which can also correspond to a complexity and/or a storage size of the model. In some examples, filtering the phase component does not require as large of a model as what is needed for the magnitude component. For example, the model for the phase component may be less complex than the model for the magnitude component such that the model for the phase component may have a smaller byte size than that of the model for the magnitude component. Although model size may not necessarily correlate to performance, practical considerations of implementation and storage can favor smaller models that may require less storage space. Further, as described herein, the ML model for the phase component can be quantized to reduce its size.

In examples where sound signal 122 has been split into overlapping segments, each segment is filtered by applying the appropriate ML model for each segment's components (e.g., phase and magnitude).

At step 506 one or more of the systems described herein generates a filtered sound signal by transforming, from the frequency domain into the time domain, the transformed sound signal comprising the magnitude component (which can be filtered) and the filtered phase component. For example, transform module 104 generates filtered sound signal 128 by transforming filtered feature 136 from the frequency domain into the time domain.

The systems described herein can perform step 506 in a variety of ways. In one example, filter module 110 recombines the extracted features of transformed sound signal 124. For instance, filter module 110 recombines filtered feature 136 (e.g., the filtered phase component) with other features (e.g., the magnitude component) which have also been filtered. Thus, a filtered transformed sound signal 124 includes one or more filtered features 136 (e.g., the filtered phase component and the filtered magnitude component).

Transform module 104 transforms the filtered transformed sound signal 124 from the frequency domain back into the time domain to generate filtered sound signal 128. In some examples, transform module 104 uses an inverse Fourier transform that corresponds to the Fourier transform in step 502.

In examples where sound signal 122 has been split into overlapping segments, generating filtered sound signal 128 further includes transforming the overlapping segments from the frequency domain into the time domain, and reconstructing the segments into filtered sound signal 128. Because the segments can overlap in time, reconstructing the segments can include an overlap-add that includes an overlapping addition of the overlapping portions.

Short-time Fourier-transform (STFT)-based AI noise reduction methods for real-time speech/source separation can convert the source signal using STFT into a frequency domain, take the magnitude and phase of the STFT-transformed signal, pass the magnitude through a trained deep neural network (DNN) model to generate a mask, multiply the magnitude by the mask, and finally take the original phase and modified magnitude and convert them back to the time domain with overlap-add. The present disclosure provides for a similar, but smaller trained DNN in the phase path to generate a mask for the phase that is multiplied by the source signal phase in a similar manner as the magnitude. The two networks can optionally be run in parallel. Unlike other unified noise suppression networks that pass the entire time-domain audio signal or both the real and imaginary parts of a complex number representation of the transformed signal through a DNN model, the DNN models described herein can both be quantized without significant degradation to the dynamic range of the source signal and without significant degradation to the speech quality of the source signal. In addition, the use of phase and magnitude as separate feature components instead of using the real and imaginary parts of a complex number representation as feature components allows the phase component to use a smaller ML model than the corresponding magnitude component ML model, which can reduce the overall size of the combined models without sacrificing the capability of removing both magnitude and phase noise components from the source signal.

Quantized DNN networks can be smaller and more power-efficient than full-precision DNN networks. AI noise suppression models that can be quantized, for instance to int8, can be implemented on more power-efficient accelerators and save substantial system power. By adding a trained mask generator for the phase as well as the magnitude, the systems and methods described herein allow the model training to directly train to mask the impacts of noise on the source signal phase as well as the magnitude, without sacrificing dynamic range or adding significant quantization error to the source audio signal.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SOCs), digital signal processors (DSPs), Neural Network Engines (NNEs), accelerators, graphics processing units (GPUs), portions of one or more of the same, variations or combinations of one or more of the same, or any other suitable physical processor.

Although illustrated as separate elements, the modules described and/or illustrated herein represent portions of a single module or application. In addition, in certain implementations one or more of these modules represent one or more software applications or programs that, when executed by a computing device, cause the computing device to perform one or more tasks. For example, one or more of the modules described and/or illustrated herein represent modules stored and configured to run on one or more of the computing devices or systems described and/or illustrated herein. One or more of these modules can also represent all or portions of one or more special-purpose computers configured to perform one or more tasks. Moreover, one or more of the modules described here can be implemented as a circuit.

In addition, one or more of the modules described herein can transform data, physical devices, and/or representations of physical devices from one form to another. For example, one or more of the modules recited herein can receive sound data to be transformed, transform the sound data, output a result of the transformation to generate a mask, use the result of the transformation to filter out noise, and store the result of the transformation to create a noise-suppressed signal. Additionally or alternatively, one or more of the modules recited herein can transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A method comprising:
transforming, by a transform module from a time domain into a frequency domain, a sound signal into a transformed sound signal comprising a magnitude component and a phase component;
filtering, by an artificial intelligence (Al) module, the phase component of the transformed sound signal by applying, to the phase component, a quantized mask that is dynamically generated from a machine-learning model using the phase component; and
generating, by the transform module, a filtered sound signal by transforming, from the frequency domain into the time domain, the transformed sound signal comprising the magnitude component and the filtered phase component.

2. The method of claim 1, wherein applying the quantized mask further comprises:
dequantizing the quantized mask; and
applying the dequantized mask to the phase component to filter the phase component.

3. The method of claim 1, wherein the Al module generates the quantized mask using the machine-learning model.

4. The method of claim 1, further comprising filtering the magnitude component of the transformed sound signal by applying a second machine-learning model; and
wherein generating the filtered sound signal further comprises transforming, by the transform module from the frequency domain into the time domain, the transformed sound signal comprising the filtered magnitude component and the filtered phase component.

5. The method of claim 4, further comprising filtering, by the Al module, the phase component in parallel with filtering the magnitude component.

6. The method of claim 4, wherein the machine-learning model for the phase component is smaller than the second machine-learning model for the magnitude component.

7. The method of claim 1, wherein:
transforming the sound signal into the transformed sound signal further comprises:
splitting, by the transform module, the sound signal into overlapping segments; and
transforming, by the transform module, the overlapping segments from the time domain into the frequency domain;
filtering the phase component further comprises filtering, by the Al module, the phase component of each of the overlapping segments by applying the machine-learning model; and
generating the filtered sound signal further comprises:
transforming, by the transform module, the overlapping segments from the frequency domain into the time domain; and
reconstructing, by the transform module, the segments into the filtered sound signal.

8. The method of claim 1, wherein the machine-learning model is trained to filter noise.

9. The method of claim 1, wherein transforming the sound signal from the time domain into the frequency domain uses a Fourier transform and transforming the filtered sound signal from the frequency domain into the time domain uses an inverse Fourier transform.

10. A system comprising:
a physical memory;
at least one physical processor;
a transform circuit configured to transform, from a time domain into a frequency domain, a sound signal into a transformed sound signal comprising a first feature component and a second feature component; and
an artificial intelligence (Al) circuit configured to filter the first feature component of the transformed sound signal by applying, to the first feature component, a quantized mask that is dynamically generated from a first machine-learning model using the first feature component and filtering the second feature component of the transformed sound signal by applying a second machine-learning model to the second feature component;
wherein the transform circuit is further configured to generate a filtered sound signal by transforming, from the frequency domain into the time domain, the transformed sound signal comprising the filtered first feature component and the filtered second feature component.

11. The system of claim 10, wherein the Al circuit is configured to apply the quantized mask to the first feature component by:
dequantizing the quantized mask; and
applying the dequantized mask to the first feature component.

12. The system of claim 10, wherein the Al circuit is further configured to filter the first feature component in parallel with filtering the second feature component.

13. The system of claim 10, wherein the first machine-learning model is smaller than the second machine-learning model.

14. The system of claim 10, wherein the first feature component corresponds to a phase component and the second feature component corresponds to a magnitude component.

15. The system of claim 10, wherein:
the transform circuit is further configured to transform the sound signal into the transformed sound signal by:
splitting the sound signal into overlapping segments; and
transforming the overlapping segments from the time domain into the frequency domain;
the Al circuit is further configured to filter the first feature component by filtering the first feature component of each of the overlapping segments by applying the quantized mask from the first machine-learning model;
the Al circuit is further configured to filter the second feature component by filtering the second feature component of each of the overlapping segments by applying the second machine-learning model; and
the transform circuit is further configured to generate the filtered sound signal by:
transforming the overlapping segments from the frequency domain into the time domain; and
reconstructing the segments into the filtered sound signal.

16. The system of claim 10, wherein the first machine-learning model is trained to filter noise from the first feature component and the second machine-learning model is trained to filter noise from the second feature component.

17. A non-transitory computer-readable medium comprising one or more computer executable instructions that, when executed by at least one processor of a computing device, cause the computing device to:
transform, from a time domain into a frequency domain, a sound signal into a transformed sound signal comprising a phase component and a magnitude component;
filter the phase component of the transformed sound signal by applying, to the phase component, a quantized mask that is dynamically generated from a first machine-learning model using the phase component;
filter the magnitude component of the transformed sound signal by applying a second machine-learning model to the magnitude component; and
generate a filtered sound signal by transforming, from the frequency domain into the time domain, the transformed sound signal comprising the filtered phase component and the filtered magnitude component.

18. The non-transitory computer-readable medium of claim 17, wherein the instructions for applying the quantized mask further comprises instructions for:
dequantizing the quantized mask; and
applying the dequantized mask to filter the phase component.

19. The non-transitory computer-readable medium of claim 17, further comprising instructions for filtering the phase component in parallel with filtering the magnitude component.

20. The non-transitory computer-readable medium of claim 17, wherein the first machine-learning model is smaller than the second machine-learning model.
